(19) United States
(12) Patent Application Publication
(10) Pub. No.: US 2004/0093228 A1
(43) Pub. Date: May 13, 2004

(54) System and methodology for mobile e-services

(76) Inventors: Carollyn Carson, Bayonne, NJ (US); Roberto Sanchez, Vallejo, CA (US); Gerald Winsor, San Jose, CA (US); Christopher Peltz, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/292,196

(22) Filed: Nov. 12, 2002

(51) Int. Cl. G06F 17/60

(52) U.S. Cl. 705/1; 705/7

(57) ABSTRACT

A system and method is disclosed for invoking a mobile electronic service (MES).

### CROSS-REFERENCE TO RELATED APPLICATIONS

This application is related to [concurrently filed and] commonly assigned U.S. patent application Ser. No. ______ entitled “A SYSTEM AND METHODOLOGY FOR MOBILE E-SERVICES”, attorney docket number 200206067-1; and [concurrently filed and] commonly assigned U.S. patent application Ser. No. ______ entitled “A TAXONOMY FOR MOBILE E-SERVICES”, attorney docket number 200206272-1, the disclosures of which are hereby incorporated herein by reference.

### BACKGROUND

“Web services” is the term currently used within the software industry to signify functionality or “services” that are accessed over a network such as the Internet or World Wide Web (the “Web”). Such a service operates as follows: the client electronically submits a request and, perhaps, some input data that is transmitted across the network to the service. A client may be another software application, another web service, hardware, and the like. The service receives the transmission and performs some operation. The service may then return a response to the requesting client. The nature of the input data, the operation performed, etc., will depend on what the service is and what it does.

Web services are the infrastructure services or applications that provide some component or functionality to an overall, complete solution delivered via the Internet. For example, a web service may encapsulate or utilize a database. The client may submit a request that a search of the database be performed and a keyword to search for. The web service then searches the database and returns the search result to the requesting client. Web services may be simple, such as a service that returns a stock quote, or complex, such as a service that allows users to make car rental reservations or complete a loan application. Electronic services (e-services) are the complete solution delivered via the Internet that may use several web services. Web- and e-services are proliferating across the Internet driving c-commerce and business-to-business (B2B) commerce.

At present, more and more web- and e-services are being offered on the Web. There is a great rush to develop Web services and make them available to the vast clientele on the Internet. Developers are in constant need of better methods, tools, etc. for developing and implementing Web services. Reducing the time required to fully implement a Web service is a key priority. Additionally, with the increase in mobile access devices, new and existing web- and e-services are desired to be delivered over mobile access networks. Moreover, as the number of such mobile e-services (MES) grows, it becomes important to provide a means of discovering the appropriate service at any given time and for any given location.

The Universal Description, Discovery and Integration (UDDI) for Web services is an industry initiative to promote the interoperability and adoption of web- and e-services. (See www.UDDI.org). The UDDI includes a global business registry of services available on the Internet. This registry has a standard Application Program Interface (API) and lists Web service providers, the services available and electronic access instructions for those services. The increased complexities of real time personalization in mobile services, which are not typically found in other traditional Internet e-services, extend beyond the existing taxonomy schemes incorporated into UDDI.

### SUMMARY

Embodiments are directed to a method for invoking a mobile electronic service (MES) comprising the steps of assessing a need for using the MES, discovering a desired MES according to the assessed need, analyzing a technology of the desired MES, acquiring access information related to the desired MES, designing an interface to the MES, setting up an environment for hosting the interface, developing the interface according to the designing step, testing the developed interface, deploying the interface onto the environment, monitoring the deployed interface, and invoking the deployed interface.

Additional embodiments are directed to a system for incorporating a mobile electronic service (MES) into a mobile application framework comprising means for assessing a use of the MES, means for discovering an appropriate MES according to the means for assessing, means for analyzing a technology of the appropriate MES, means for acquiring access information for the appropriate MES, means for designing an interface to the appropriate MES, means for setting up an environment for running the interface, means for developing the interface according to the means for designing, means for testing the developed interface, means for installing the interface onto the environment, means for monitoring the installed interface, and means for invoking the installed interface.

Further embodiments are directed to a system for invoking a mobile electronic service (MES) comprising a business analyst for analyzing a business feasibility of using the MES, an architect for analyzing a technology of the MES. The architect also acquires access means for the MES and designs an interface to the MES. Also included are an administrator for assisting in setting up an environment for the interface and an engineer for developing the interface according to the design. The engineer also assists the administrator in setting up the environment and also tests the developed interface. The system further includes an operations entity for deploying the interface onto the environment, monitoring the deployed interface. The system further includes a subscriber for invoking the MES through the interface.

### BRIEF DESCRIPTION OF THE DRAWINGS

Reference is now made to the following figures:

FIG. 1 is a flowchart illustrating a web service development paradigm;

FIG. 2 is a high-level block diagram illustrating an embodiment of a mobile e-services life cycle;

FIG. 3 is a high-level block diagram illustrating an embodiment of the static invocation model of the MESLC shown in FIG. 2;

FIG. 4 is a flowchart illustrating the main procedures of an embodiment of the MESLC creation model; and

FIG. 5 is a flowchart illustrating another embodiment of the MESLC creation model; and

FIG. 6 is a high-level block diagram of another embodiment of the MESLC described herein.

### DETAILED DESCRIPTION

Co-pending, commonly assigned patent application entitled, “A SYSTEM AND METHODOLOGY FOR MOBILE E-SERVICES”, Ser. No. ______, [attorney docket number 200206067-1], defines a static invocation method as a part of the overall mobile e-service (MES) development lifecycle (MESLC). MESLC leverages technology described in a co-pending, commonly assigned patent application entitled, “A METHOD OF DEVELOPING A WEB SERVICE AND MARKETING PRODUCTS OR SERVICES USED IN DEVELOPING A WEB SERVICE”, Ser. No. ______, [attorney docket number 100200137-1]. The web services development life cycle (WSDLC) described in the related application provides a web service development paradigm that may be divided into nine steps or phases that may be performed in various orders to fully implement a web service. The embodiments described herein disclose the details of the static invocation model contemplated by the MESLC.

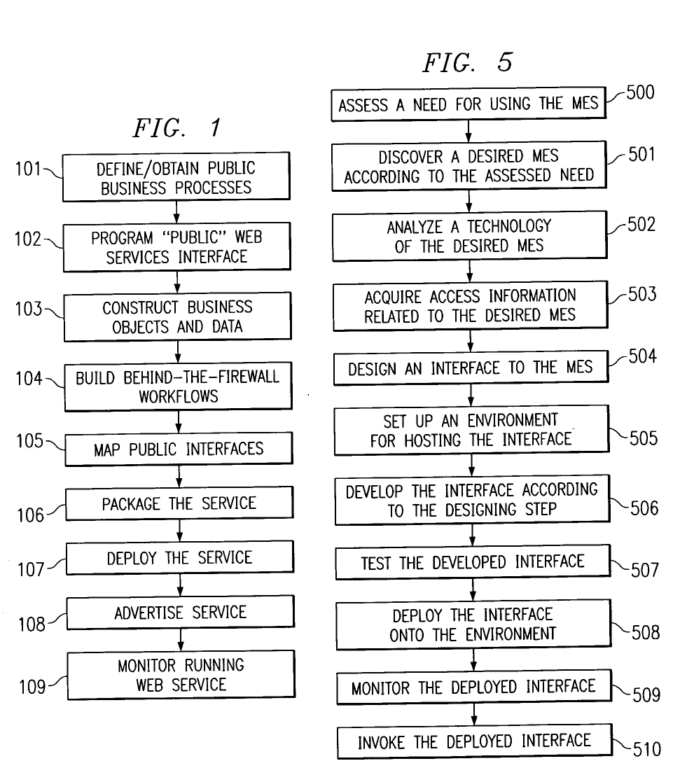

FIG. 1 is a flowchart illustrating a web service development paradigm. These phases are illustrated one order. However, the phases can be performed in many other possible orders under the principles of the above-referenced related patent application. The model describing the WSDLC may include the following steps: (1) define or obtain public business processes, in step 101, (2) program Web service interface for the public or authorized clients, in step 102, (3) construct business objects and data, in step 103, (4) build the behind-the-firewall workflows, in step 104, (5) map the “public” interfaces, in step 105, (6) package the services, in step 106, (7) display the services, in step 107, (8) advertise the services, in step 108, and (9) monitor the operation of the Web service, in step 109.

The MESLC is an extension to the WSDLC. Because the MESLC generally targets a specific audience, such as hosts of mobile networks or ecosystems and providers of services to these ecosystems, business considerations as well as technical decisions will be addressed in the life cycles. Due to the complexities involved with MES participants or users and the roles they assume, entities and roles are also defined and discussed.

While portions of the WSDLC are incorporated into the MESLC, the MESLC also provides (1) focus on the mobile operators/service providers within the mobile market or ecosystem; (2) inclusion of the business assessment process; (3) further focus on the design and technology assessment process for the creation and invocation of MES; (4) emphasis on the hosting model for the mobile providers and operators; and (5) emphasis on testing of a web service.

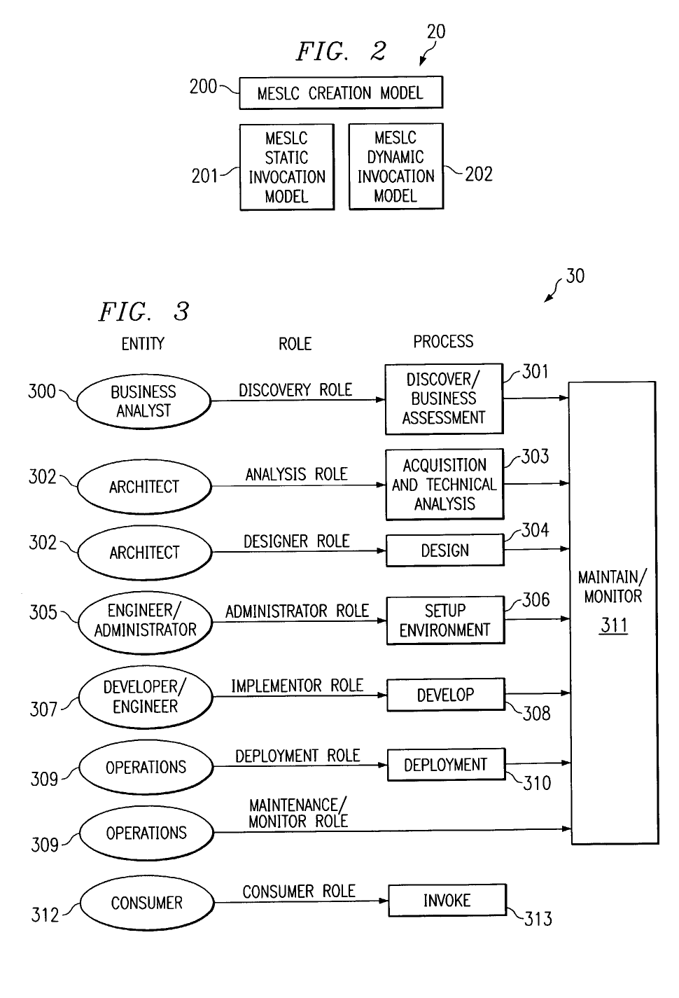

The MESLC offers a MES provisioning model and how it aligns with the MESLC's entity, role, and process definitions. FIG. 2 is a high-level block diagram illustrating one embodiment of a mobile e-services life cycle. MESLC 20 includes three interrelated models. MESLC creation model 200, as described in greater detail below, includes the methodology for creating the MES. The model incorporates both the business and technical assessments as part of the overall MESLC definition and methodology. MESLC static invocation model 201, disclosed herein, involves the invocation of a particular MES for a static workflow. MESLC dynamic invocation model 202 involves the invocation of a e-service searching tool that searches for compatible and desired MES for operation. The major difference between MESLC static invocation model 201 and MESLC dynamic invocation model 202 is that the static invocation has a specific MES bound to the invocation method at design time while the dynamic invocation includes a searching tool that finds the appropriate MES at runtime. MESLC 20 is intended to build upon the WSDLC and will provide additional scope and focus on the mobile industry and services.

FIG. 3 is a high-level block diagram illustrating static invocation model 30 of an embodiment of the MESLC described herein. Static invocation model 30 comprises a number of entities and corresponding roles and processes for invoking MES. Business analyst 300 preferably performs a discovery role in discover/business assessment process 301. Business analyst 300 preferably assesses the business needs or feasibility when looking at MES. Decisions, such as whether to supplement an existing application with a MES or providing a complete MES solution, will preferably be made.

Once a decision has been made to use a MES, business analyst 300 may search for the appropriate MES to use. Business analyst 300 may contact a MES provider directly or may access a MES registry, such as the UDDI to search for web- or e-services registered therein. Private registries of this type may require passwords or accounts, but business analyst 300 may be able to log onto a UDDI registry to search for specific MES.

A UDDI registry may have an interface that allows business analyst 300 to perform text or keyword searches of the repositories. A search may be performed using any number of identifying criteria, such as company name, service type, taxonomy classifier, categories, and the like. An example of a taxonomy specifically directed to MES is found in co-pending, commonly assigned U.S. patent application Ser. No. ______ entitled “A TAXONOMY FOR MOBILE E-SERVICES”, attorney docket number 200206272-1. Business analyst 300 may also qualify the MES to establish the necessary items or guidelines that may have to be met to access the desired MES.

Architect 302 may perform an analysis role in acquisition and technical analysis process 303. Before the company commits to a particular MES, architect 302 may analyze not only whether the desired functionality will be provided by the MES, but also whether it is technically viable considering the company's systems. Architect 302 may also typically extract the WSDL file for use by the developers.

After analyzing the technical feasibility, architect 302 may begin the acquisition process. SOAP access points are typically found from the WSDL file. These access points may be incorporated into the software by the developers. An additional technical analysis may be performed by architect 302 to ensure compatibility between the SOAP version of the acquired access points and the SOAP server being run by the company.

Architect 302 also may perform a designer role in design process 304. To invoke a MES, a client proxy may be developed. This may require a standalone client or client proxy software integrated into existing applications. If the MES is a mobile e-service, which implies an existing interface, design process 304 may be skipped if the user will directly invoke the MES. However, if the MES is to be integrated with an existing interface, design process 304 may incorporate it.

Design and creation of a client proxy may entail designing the client proxy software, incorporating WSDL-compliant proxy code, and then integrating the application with any backend components. If integrating a MES that is a mobile e-service into a portal or existing interface, then the design may need to address the incorporation of the uniform resource locator (URL) binding to allow the service to be invoked from another interface. Architect 302 may work with the existing interface and incorporate it into the overall application. An example would be the incorporation of the MES URL binding into a portal interface.

Engineer/Administrator 305 may perform an administration role in setup environment process 306. Engineer/Administrator 305 may generally comprise a single, dual-purpose engineer/administrator, or may comprise separate engineering and administration entities. The administrator portion of engineer/administrator 305 may typically be found in the administration of access points and login accounts for particular MES ecosystems or hosted environments. The engineer portion of engineer/administrator 305 may perform hardware and software configuration and development tasks. Setup environment process 306 for static invocation model 30 is very similar to the environmental setup process in co-pending, commonly assigned U.S. patent application entitled, “A METHOD OF DEVELOPING A WEB SERVICE AND MARKETING PRODUCTS OR SERVICES USED IN DEVELOPING A WEB SERVICE,” Ser. No. ______, [attorney docket number 100200137-1].

Environment setup 306 may address the hardware, software, and access to be provided in the various environments. For larger projects, architect 302 may provide a plan for the environments used for implementation and testing. Environmental setup 306 may include further consideration of hardware, consideration of the software tools and products, and access methods for providing the MES. Depending on whether the hardware platforms will be hosted locally or accessed remotely, platforms may be acquired and set up according to architect 302's direction.

Access to remotely hosted environments may be provided through virtual private network (VPN) software which enables secure application delivery over the Internet. Clients may load the VPN software for remote connectivity. This technology can also be used when establishing backend connections via TCP/IP to a remote environment, as is the case when using a remotely hosted EJB. Software components for the development of applications may also be installed, such as JAVA SDK or C++ compilers, or .NET framework, and the like.

Hosted environments may also use VPN software to enable remote access. IP addresses may generally be provided by the hosted environment to allow for developer and test access. Furthermore, because MES access may typically occur behind the firewall, the necessary ports may need to be opened for the application servers hosting the SOAP service.

Engineer/Administrator 305 also may perform an implementor role in develop process 308. Develop process 308 may be the implementation of design process 304 performed by architect 302. In development process 308, engineer/administrator 305 may perform the coding and implementation for creating the client proxy software, integrating the client proxy into an existing application, if necessary, and performing any integration necessary with the backend applications.

Operations 309 may perform both a deployment role in deployment process 310 and a maintenance/monitoring role in maintain/monitor process 311. Operations 309 may preferably account for any access that occurs through corporate firewalls or hosted environments. Both deployment process 310 and maintain/monitor process 311 are substantially similar to those same processes in co-pending, commonly assigned U.S. patent application entitled, “A METHOD OF DEVELOPING A WEB SERVICE AND MARKETING PRODUCTS OR SERVICES USED IN DEVELOPING A WEB SERVICE,” Ser. No. ______, [attorney docket number 100200137-1].

Deployment process 310 may simply include the process of deploying the service onto a SOAP server which is, itself, deployed on an application server, such as any JAVA 2 ENTERPRISE EDITION (J2EE) application server. The service may be deployed onto the SOAP server after successfully completing all phases of testing. Further testing may be done when the MES and all of its components have been appropriately deployed by testing the external invocation of the live MES.

Maintain/Monitor process 311 may be an on-going process for monitoring and maintaining the live MES. If the MES is registered into a UDDI registry where the host requires adherence to a service level agreement, operations 309 may closely monitor the service to ensure the contract service levels are not violated. Maintain/Monitor process 311 may also include the on-going consideration of configuration and tuning of the MES, maintenance of documentation associated with the MES, monitoring the performance, availability, and usage growth, monitoring the hardware and storage, and monitoring of peripheral service and software, such as an application server, SOAP server, networks, security, and the like. These monitoring and maintenance tasks may include such devices as a help desk and/or controlled access to the system.

Consumer 312 may perform the consumer role in invoke process 313. Consumer 312 may be the entity that invokes and consumes the MES. Client 312 may invoke the MES either via client software or through a larger application or direct invocation to a complete MES solution. Invoke process 313 may simply be the execution of the MES.

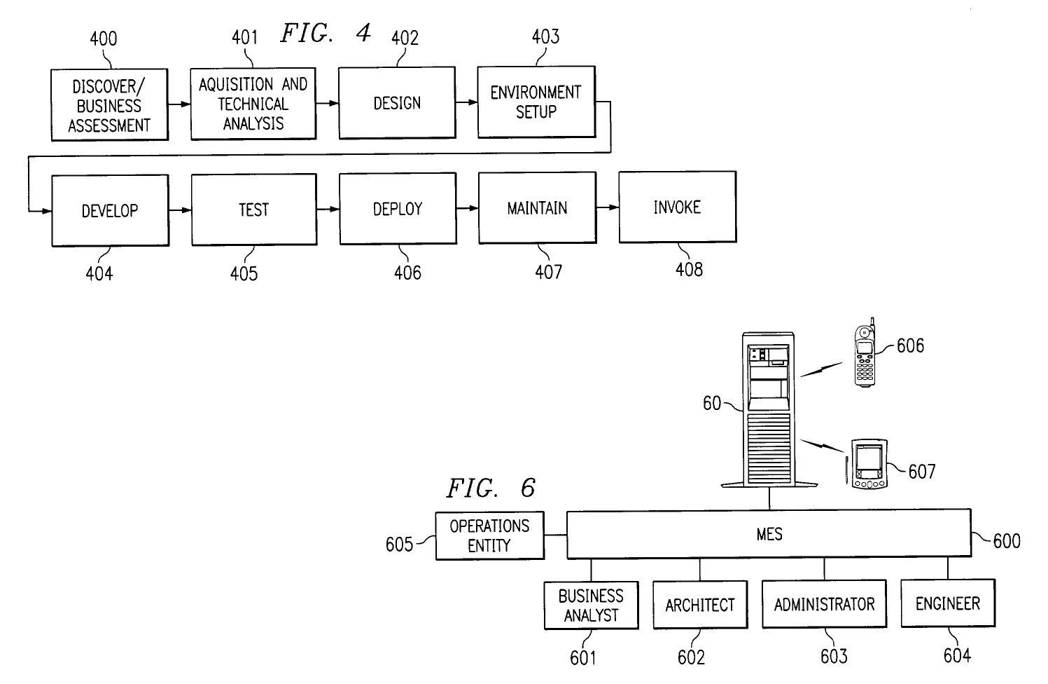

FIG. 4 is a flowchart illustrating the main procedures of an embodiment of the MESLC creation model. In step 400, a business analyst may make a business assessment regarding the use of a MES and then discovers an appropriate MES. In step 401, an architect may perform a technical analysis of the desired MES and retrieve the necessary information to acquire the MES, such as obtaining the WSDL file. The architect then may design the client software and interface in step 402 for invoking the MES and possibly integrating with any appropriate backend systems. In step 403, an engineer/administrator may set up the environment for the client software/interface. The engineer/administrator may acquire the appropriate hardware, software, tools, and the like necessary to setup the environment. In step 404, a developer/engineer may implement the designed client software, MES interface, and provides any connections to backend systems. In step 405, the developed client software and MES interfaces may be tested. Once testing has been completed and has been successful, the client software and interface may be moved, in step 406, to the production environment and tested again in place. In step 407, the operations personnel or systems may maintain and monitor the system, including maintaining any necessary documentation. In step 407, a consumer may invoke the MES or MES client.

FIG. 5 is a flowchart illustrating another embodiment of the MESLC creation model. In step 500, a need for using the MES is assessed. In step 502, a desired MES is discovered according to the assessed need. In step 503, a technology of the desired MES is analyzed. Access information is acquired related to the desired MES in step 504. In step 505, an interface to the MES is designed. In step 506, an environment is set up for hosting the interface. The interface is developed according to the designing step in step 507. In step 508, the developed interface is tested. The interface is then deployed onto the environment in step 509. After deployment, the interface is monitored in step 510. In step 511, the deployed interface is invoked.

FIG. 6 is a high-level block diagram of another embodiment of the MESLC described herein. Prior to development of MES 600, business analyst 601 analyzes a business feasibility of using MES 600. Architect 602 analyzes a technology of MES 600 and designs an interface. Administrator 603 assists in setting up an environment for the interface. Engineer 604 codes and develops the interface according to architect 602's design. Engineer 604 also assists administrator 603 in setting up the environment. Another task implemented by engineer 604 is to tests the developed interface. Operations entity 605 actually deploys the interface onto the environment, which may be implemented on server 60. Operations entity 605 also monitors the interface as MES 600 is operating. Subscribers, such as subscribers 606 and 607 may then invoke MES 600 through the interface on server 60.

What is claimed is:

1. A method for invoking a mobile electronic service (MES) comprising the steps of:
assessing a need for using said MES;
discovering a desired MES according to said assessed need;
analyzing a technology of said desired MES;
acquiring access information related to said desired MES;
designing an interface to said MES;
setting up an environment for hosting said interface;
developing said interface according to said designing step;
testing said developed interface;
deploying said interface onto said environment;
monitoring said deployed interface; and
invoking said deployed interface.

2. The method of claim 1 wherein said assessing step includes:
determining a business feasibility;
determining a technical feasibility; and
qualifying a provider of said desired MES.

3. The method of claim 1 wherein said discovering step includes:
accessing a MES registry; and
searching said MES registry.

4. The method of claim 1 wherein said acquiring step includes:
locating a service description file related to said desired MES;
retrieving said service description file; and
retrieving information regarding an access point for said desired MES.

5. The method of claim 4 wherein said service description file comprises a Web Services Description Language (WSDL) file.

6. The method of claim 4 wherein said information regarding said access point comprises a Simple Object Access Protocol (SOAP) access point.

7. The method of claim 4 wherein said designing step includes:
designing client proxy software;
incorporating proxy code compliant with said service description file; and
integrating with available backend components.

8. The method of claim 4 wherein said developing step includes:
coding client proxy software using service description file-compliant code; and
coding an interface to integrate available backend components.

9. The method of claim 1 wherein said invoking step includes:
invoking said desired MES, wherein said MES is invoked using one of:
a standalone client application; and
a client proxy.

10. A system for incorporating a mobile electronic service (MES) into a mobile application framework comprising the steps of:
means for assessing a use of said MES;
means for discovering an appropriate MES according to said means for assessing;
means for analyzing a technology of said appropriate MES;
means for acquiring access information for said appropriate MES;
means for designing an interface to said appropriate MES;
means for setting up an environment for running said interface;
means for developing said interface according to said means for designing;
means for testing said developed interface;
means for installing said interface onto said environment;
means for monitoring said installed interface; and
means for invoking said installed interface.

11. The method of claim 10 wherein said means for assessing includes:
means for analyzing a business feasibility;
means for analyzing a technical feasibility; and
means for qualifying a provider of said desired MES.

12. The method of claim 10 wherein said means for discovering includes:
means for accessing a MES registry; and
means for searching said MES registry.

13. The method of claim 10 wherein said means for acquiring includes:
means for detecting a service description file related to said desired MES;
means for obtaining said service description file; and
means for obtaining information regarding an access point for said desired MES.

14. The method of claim 13 wherein said service description file comprises a Web Services Description Language (WSDL) file and said information regarding said access point comprises a Simple Object Access Protocol (SOAP) access point.

15. The method of claim 13 wherein said means for designing includes:
means for designing client proxy software;
means for using proxy code compliant with said service description file; and
means for assimilating with available backend components.

16. The method of claim 10 wherein said means for invoking includes:
means for invoking said desired MES, wherein said MES is invoked using one of:
a standalone client application; and
a client proxy.

17. A system for invoking a mobile electronic service (MES) comprising:
a business analyst for analyzing a business feasibility of using said MES;
an architect for analyzing a technology of said MES;
said architect acquiring access means for said MES;
said architect designing an interface to said MES;
an administrator for assisting in setting up an environment for said interface;
an engineer for developing said interface according to said design, wherein said engineer assists said administrator in setting up said environment and wherein said engineer tests said developed interface;
an operations entity for deploying said interface onto said environment;
said operations entity monitors said interface; and
a subscriber for invoking said MES through said interface.
